(19) United States
(12) Patent Application Publication
(10) Pub. No.: US 2004/0253349 A1
(43) Pub. Date: Dec. 16, 2004

(54) Frozen food product in a tray for microwave heating

(76) Inventors: Tetsuya Kato, Portland, OR (US); Shin-ichi Kamiya, Portland, OR (US)

Correspondence Address: SMITH PATENT OFFICE, 1901 PENNSYLVANIA AVENUE N W, SUITE 200, WASHINGTON, DC, 20006

(21) Appl. No.: 10/458,583

(22) Filed: Jun. 11, 2003

(51) Int. Cl. A23G 1/00

(52) U.S. Cl. 426/100

(57) ABSTRACT

A frozen food product is disclosed which includes an ingredient at least partially covered by a sauce where the sauce comprises water, gelatin and at least one of a modified starch and gum. The frozen food product can include rice and/or noodles that may be covered by meat and/or vegetables. A sauce is added to at least partially cover the basic products. The sauce is made so that its viscosity is adjusted to between 5-50 mPa·s at 25° C. The sauce also includes a modified starch or gum to adjust the viscosity. It is also possible to include a gelatin in the sauce, if desired. A method of making a frozen food product is also disclosed.

### BACKGROUND OF THE INVENTION

1. Field of the Invention

The present invention relates to a food product that is stored in a microwavable heat resistant container such as a tray or dish and maintains its quality after being frozen and then heated in a microwave oven. The frozen food product typically has a sauce topping over rice or noodles so as to cover the rice or noodles with the sauce. The invention also relates to the process for making the food product.

2. Discussion of the Related Art

When a frozen food product is heated in a microwave oven, the product typically becomes partially dry due to uneven heating and loss of moisture in the food product.

In the past, these types of food products became partially dried after heating and lacked moisture in certain parts of the food product due to uneven heating. Thus the quality of the food product deteriorated after heating the frozen food in the microwave oven. Several methods have been tried to solve these problems.

For example, according to Japanese Patent Laid-Open Publication No. H10-066525, the applicant tried to protect rice from over evaporation. This method used a sheet of food material between the main ingredients such as rice and/or noodles and the sub-ingredients such as vegetables and/or meats. By using this method, the quality of the main ingredients is maintained; however, this method did not prevent deterioration in the quality of the sub-ingredients such as the vegetables and/or meats.

According to another method disclosed in Japanese Patent Laid-Open Publication No. 2001-037434, the applicant tried to protect a mixed product of pasta and a sauce. This method added a gelatin to the sauce contents so that the sauce was in gel form. The addition of a gelatin prevented some deterioration in the quality of the product; however, the mere addition of gelatin did not work well enough to prevent significant deterioration in quality of the food product and specifically including the pasta.

### SUMMARY OF THE INVENTION

An object of the present invention is to provide a high quality food product that maintains its quality after being frozen for some time followed by being heated in a microwave oven.

It is also another object of the present invention to provide a food product that prevents evaporation of water from meats, vegetables and/or other ingredients during freezing and subsequent microwave heating.

It is also another object of the present invention to provide a food product that is easy to manufacture and provides protection against freezer burn and uneven heating in the microwave oven.

These objects are achieved in part by preventing the surface of the frozen food product from drying out thereby deteriorating the quality of the food product.

This invention specifically solves the problem of the drying out of the food product during microwave heating. Specifically, the present invention prevents various ingredients, including those ingredients used as a topping, from drying out and maintains a juicy texture for the ingredients when the product is heated in a microwave oven.

In one embodiment of the present invention, the weight and juicy texture of the food ingredients disposed on rice and/or noodles in a frozen food product to be heated in a microwave is maintained by covering the food ingredients with a sauce. The sauce contains modified starch or gum added to adjust the viscosity of the sauce to between 5 to 50 mPa·s at 2.5° C., using a Model DV-I+ Viscometer. It is also possible to add a gelatin to make the sauce into a more gel like form.

The present invention is accomplished by a frozen food product disposed in a heat resistant container comprising an ingredient at least partially covered by a sauce, wherein the sauce has a viscosity of 5-50 mPa·s at 25° C.

The present invention is also achieved by a frozen food product disposed in a heat resistant container comprising at least one of rice and noodles disposed in a lower portion of the container; at least one of a meat product and a vegetable product disposed on the rice and/or noodles; and a sauce substantially covering the meat product and/or vegetable product, wherein the sauce has a viscosity of 5-50 mPa·s at 25° C.

The present invention also relates to a method of making the frozen food product. The method comprises the steps of adding at least one of rice and noodles to a heat resistant container; adding a meat and/or vegetable to the rice and/or noodles; preparing a sauce having a viscosity of 5-50 mPa·s at 25° C.; at least partially covering the meat and/or vegetable with the sauce; and freezing the food product. The sauce can be prepared by including at least one of a modified starch and a gum. It is desirable to add an amount of modified starch and/or gum from 0.8-2.5% by weight to achieve the desired viscosity. It is also possible to add a gelatin.

### DETAILED DESCRIPTION OF THE PREFERRED EMBODIMENTS

The inventors solved the above-mentioned problems by providing a composition and method that obtains juicy texture ingredients after microwave heating.

Based on their studies, the inventors determined that as microwave heating begins, the surface of a sauce, which is provided over the food ingredients, is thawed out. Subsequently, the sauce liquefies and it is then soaked into the meat and/or vegetables and the rice and/or noodle ingredients at the beginning stages of microwave heating.

If the viscosity of the sauce is very low, the sauce is completely soaked into the rice and/or noodle ingredients by the end of the cooking time so the evaporation of water from the ingredients is accelerated by direct heating in the microwave oven during the middle and end stages of the heating process. Even if the sauce contains a gelatin, the viscosity of the sauce quickly goes down upon microwave heating and the sauce does not protect the product from evaporation.

According to the present invention, the viscosity of the sauce is adjusted so that the sauce will stay partially over the ingredients during the heating process. The viscosity was measured using a Viscometer Model DV-I+ from Brookfield Inc. according to the instructions in the User's Manual No. M/92-021-A-892. This adjusted viscosity prevents the product from being overheated directly by the microwave heating process. It also allows the sauce to help protect the product from evaporation. Thus the main heating of the product is done in the final stages of the heating process.

This method prevents excessive evaporation of water from the ingredients, especially the meat and/or vegetables disposed on top of rice and/or noodle ingredients and this keeps the quality of food product much higher that has been previously accomplished.

### EXAMPLES

According to the present invention, food products comprising beef, onions and a sauce were disposed over rice. Specifically, 60 grams of cooked beef and 40 grams of cooked onions were added on top of 230 grams of cooked rice (or cooked and frozen rice). The beef and onions were prepared by slicing and then they were cooked with small amounts of soy sauce and sugar as is well known. To this combination of ingredients, 70 grams of sauce was added as a topping that completely covered the beef and onions on top of the rice. This food product is typically referred to as a “beef bowl” or “gyudon”.

The sauce was prepared according to one of ten different examples described in the ten recipes discussed in Table 1. A control recipe was also prepared which included 60.2% water, 38.8% seasonings and 1.0% gelatin (all values are weight/weight percentages). The seasonings typically included sugar, soy sauce, sake, bonito extract, etc.

According to the present invention, the sauce also included a modified starch, such as a modified potato starch and/or a freezer resistant gum composition, such as Gum Xanthan Xan100 (a product of AEP Colloids). It was found that this ingredient (or these ingredients), provided in certain amounts, remarkably prevented evaporation of water from the other ingredients, and especially the beef and onions, during microwave heating.

The sauce was prepared by mixing the water and seasonings and bringing them to a boil. Subsequently, the modified starch and/or gum was added with a small amount of water to the boiling liquid to adjust its viscosity. To measure the viscosity, test samples were taken and the viscosity was measured at 25° C. Gelatin was added to the mixture shortly after the test samples were taken. The sauce was then added over the beef, onions and rice to prepare the beef bowl prior to freezing.

Following the preparation of the beef bowl products, they were frozen and subsequently heated. The products were heated for 4 minutes in a 1200 Watt microwave oven. Following this heating process, the results of a sensory evaluation and the changes in the weight of the cooked beef were evaluated. The results of the ten examples and the control sample are shown in Table 2. The viscosity of the various sauces added to the beef bowl products was also measured and these data are also included in Table 2. As discussed above, the viscosity was measured using a Viscometer Model DV-I+ from Brookfield Inc. according to the instructions in the User's Manual No. M/92-021-A-892.

As can be seen from Table 1, modified starch was added to the various sauces in various weight percentages including 0.2, 0.4, 0.6, 0.8, 1.0, 1.5, 2.0, 2.5, 3.0 and 4.0.

As can be seen from Table 2, the sensory evaluation of the beef appearance was found to be the best for Examples 4-10 as the beef was not discolored. Also, the texture of the beef was found to be the best for Examples 4-8 as the beef was juicy and tender. This indicated that excessive evaporation of water from the beef had not occurred. In Example 9, while the weight of cooked beef after heating was maintained close to the weight before cooking, the viscosity of the sauce was slightly high and made handling more difficult in preparing the beef bowl product. In Example 10, the viscosity of the sauce was very high and hindered the preparation of the food product.

According to these tests, Examples 4-8 were deemed the best overall product since they maintained a substantially constant weight of the cooked beef before and after microwave heating, they did not discolor the beef and they provided a juicy and tender beef after microwave heating.

Since the exact amount of modified starch and gum can be determined by the examples above, it is not necessary to always test the viscosity of the sauce if gelatin is to be added to the sauce as the exact amount can be added to achieve the results discussed above.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

TABLE 1
Sauce Recipe
<Control>

| | |
|---|---|
| Seasonings | 38.8%(w/w) |
| Water | 60.2 |
| Gelatin | 1.0 |
| Total | 100.0%(w/w) |

<Example 1>

| | |
|---|---|
| Seasonings | 38.8%(w/w) |
| Water | 60.0 |
| Gelatin | 1.0 |
| Modified Starch | 0.2 |
| Total | 100.0%(w/w) |

<Example 2>

| | |
|---|---|
| Seasonings | 38.8%(w/w) |
| Water | 59.8 |
| Gelatin | 1.0 |
| Modified Starch | 0.4 |
| Total | 100.0%(w/w) |

<Example 3>

| | |
|---|---|
| Seasonings | 38.8%(w/w) |
| Water | 59.6 |
| Gelatin | 1.0 |
| Modified Starch | 0.6 |
| Total | 100.0%(w/w) |

<Example 4>

| | |
|---|---|
| Seasonings | 38.8%(w/w) |
| Water | 59.4 |
| Gelatin | 1.0 |
| Modified Starch | 0.8 |
| Total | 100.0%(w/w) |

<Example 5>

| | |
|---|---|
| Seasonings | 38.8%(w/w) |
| Water | 59.2 |
| Gelatin | 1.0 |
| Modified Starch | 1.0 |
| Total | 100.0%(w/w) |

<Example 6>

| | |
|---|---|
| Seasonings | 38.8%(w/w) |
| Water | 58.7 |
| Gelatin | 1.0 |
| Modified Starch | 1.5 |
| Total | 100.0%(w/w) |

<Example 7>

| | |
|---|---|
| Seasonings | 38.8%(w/w) |
| Water | 58.7 |
| Gelatin | 1.0 |
| Modified Starch | 1.5 |
| Total | 100.0%(w/w) |

<Example 8>

| | |
|---|---|
| Seasonings | 38.8%(w/w) |
| Water | 57.7 |
| Gelatin | 1.0 |
| Modified Starch | 2.5 |
| Total | 100.0%(w/w) |

<Example 9>

| | |
|---|---|
| Seasonings | 38.8%(w/w) |
| Water | 57.2 |
| Gelatin | 1.0 |
| Modified Starch | 3.0 |
| Total | 100.0%(w/w) |

<Example 10>

| | |
|---|---|
| Seasonings | 38.8%(w/w) |
| Water | 56.2 |
| Gelatin | 1.0 |
| Modified Starch | 4.0 |
| Total | 100.0%(w/w) |

Tray Recipe

| | | |
|---|---|---|
| Cooked Beef | 60 | g |
| Cooked Onion | 40 | |
| Frozen rice | 230 | |
| Sauce | 70 | |
| Total | 400 | g |

TABLE 2

| | Viscosity of Sauce | Weight of Cooked Beef | | Sensory Evaluation | | |
|---|---|---|---|---|---|---|
| | (mPa · s)* | Before | After | | | Total |
| | 25oC) | heating (g) | heating (g) | Appearance | Texture | Evaluation |
| Control | 4 | 60 (100%) | 39 (65%) | Beef becomes dark | Beef becomes dry and tough | X |
| | | | | Especially, edges get burned | | |
| Example 1 | 4 | 60 (100%) | 47 (78%) | Beef becomes a little dark | Beef becomes a little dry | X |
| | | | | | and tough | |
| Example 2 | 4 | 60 (100%) | 50 (83%) | Beef becomes a little dark | Beef becomes a little dry | X |
| | | | | | and tough | |
| Example 3 | 4 | 60 (100%) | 56 (93%) | Beef becomes a little dark | Beef becomes a little dry | X |
| | | | | | and tough | |
| Example 4 | 5 | 60 (100%) | 58 (97%) | Beef has same color as | Beef is juicy and tender | ◯ |
| | | | | before heating | | |
| Example 5 | 7 | 60 (100%) | 60 (100%) | Beef has same color as | Beef is juicy and tender | ◯ |
| | | | | before heating | | |
| Example 6 | 8 | 60 (100%) | 60 (100%) | Beef has same color as | Beef is juicy and tender | ◯ |
| | | | | before heating | | |
| Example 7 | 9 | 60 (100%) | 59 (98%) | Beef has same color as | Beef is juicy and tender | ◯ |
| | | | | before heating | | |
| Example 8 | 52 | 60 (100%) | 63 (105%) | Beef has same color as | Beef is juicy and tender | ◯ |
| | | | | before heating | | |
| Example 9 | 78 | 60 (100%) | 58 (97%) | Beef has same color as | Viscosity is a little | X |
| | | | | before heating | too high and viscous | |
| Example 10 | 2200 | 60 (100%) | 62 (103%) | Beef has same color as | Viscosity is too high | X |
| | | | | before heating | and viscous | |

*Use Model DV-I + Viscometer

What is claimed is:

1. A frozen food product disposed in a heat resistant container comprising:
an ingredient at least partially covered by a sauce, wherein the sauce has a viscosity of 5-50 mPa·s at 25° C.

2. The frozen food product as defined in claim 1, wherein said ingredient comprises at least one of rice and noodles.

3. The frozen food product as defined in claim 1, wherein said ingredient includes at least one of a meat and a vegetable, and wherein the sauce is disposed on said at least one of a meat and a vegetable.

4. The frozen food product as defined in claim 3, wherein said frozen food product has a weight between 200-500 grams.

5. The frozen food product as defined in claim 1, wherein said sauce includes at least one of a modified starch and gum.

6. The frozen food product as defined in claim 5, wherein said sauce includes a gelatin.

7. A frozen food product disposed in a heat resistant container comprising:
at least one of rice and noodles disposed in a lower portion of the container;
at least one of a meat and vegetable disposed on said at least one of rice and noodles;
a sauce substantially covering said at least one of a meat and vegetable, wherein said sauce comprises water and at least one of a modified starch and gum.

8. The frozen food product as defined in claim 7, wherein said sauce includes modified starch in an amount greater than or equal to 0.8% by weight.

9. The frozen food product as defined in claim 8, wherein said sauce includes modified starch in an amount between 0.8-2.5% by weight.

10. The frozen food product as defined in claim 7, wherein the sauce further includes a gelatin.

11. The frozen food product as defined in claim 10, wherein said sauce includes modified starch in an amount greater than or equal to 0.8% by weight.

12. The frozen food product as defined in claim 11, wherein said sauce includes modified starch in an amount between 0.8-2.5% by weight.

13. A method of making a frozen food product comprising the steps of:
adding at least one of rice and noodles to a heat resistant container;
adding at least one of a meat and vegetable to the at least one of rice and noodles;
preparing a sauce having a viscosity of 5-50 mPa·s at 25° C.;
at least partially covering the at least one of a meat and vegetable with the sauce; and
freezing the food product.

14. The method of making a frozen food product as defined in claim 13, wherein said step of preparing a sauce having a viscosity of 5-50 mPa·s at 25° C. includes using at least one of a modified starch and a gum.

15. The method of making a frozen food product as defined in claim 13, wherein said step of preparing a sauce having a viscosity of 5-50 mPa·s at 25° C. includes using a gelatin and at least one of a modified starch and a gum.
